(19) United States
(12) Patent Application Publication
(10) Pub. No.: US 2002/0032755 A1
(43) Pub. Date: Mar. 14, 2002

(54) Registration system and method using a back end server

(76) Inventors: Marc Abrahams, San Diego, CA (US); Srikant Char, Irvine, CA (US); Kirk Imamura, Lajolla, CA (US)

Correspondence Address: William S. Frommer, Esq., c/o FROMMER LAWRENCE & HAUG LLP, 745 Fifth Avenue, New York, NY, 10151, US

(21) Appl. No.: 09/872,732

(22) Filed: Jun. 1, 2001

Related U.S. Application Data
(60) Provisional application No. 60/232,575, filed on Sep. 13, 2000.

(51) Int. Cl. G06F 15/16

(52) U.S. Cl. 709/219; 709/203

(57) ABSTRACT

Registration of a communication device with a website is provided via a back end server connected directly to an ISP, and bypassing load balanced front end server that are providing the computing power to run a website. Also, required data can be retrieved upon a system crash by directly contacting the website via a direct dial-up connection. After an initial contact is made, further communications are performed directly between an ISP and a back end server associated with the website. In this way, resources for meeting user's requests are not compromised when other users wish to register for, or otherwise use, the features of the website.

### CROSS REFERENCE TO RELATED APPLICATIONS

This application is claims the benefit of Provisional Application Serial No. 60/232,575, filed Sep. 13, 2000, the entire contents of which are incorporated herein by reference.

### BACKGROUND OF THE INVENTION

The number of websites accessible over the World Wide Web and the number of types of devices attempting to access these websites is growing. Just a few years ago only desktop computers could access the Internet and posted web pages. Quickly thereafter users were able to access websites on the World Wide Web from portable, laptop or notebook computers. Users can now access the World Wide Web via a variety of access devices. With this proliferation of types and numbers of devices available to a user, the number of ways each individual user accesses information over the Internet is multiplying. A user may have a desktop computer both at work and home, a special Internet Appliance, a handheld wireless access device, a wireless cellular telephone device and the like.

Because of this proliferation of devices, websites must recognize the type of device trying to access a particular information. This is because each of the access devices may have different operating capabilities. For example, if a handheld device includes a monochrome screen, it does not make sense to transmit color information to the handheld device. Because the monochrome data is typically smaller than the color data, transmission time is reduced.

Therefore, when a user wishes to obtain information from a particular website, the user may be asked to register at the website. This registration process will likely involve instructing the website of the operating capabilities of the access device. This may be performed by direct text entry of the information by a user or the automatic detection of the capabilities of the access device by the website. This registration process may be required for each website the user wishes to visit. This can be a cumbersome process.

Furthermore, when a user purchases a new wireless or other access device, the company manufacturing this device typically will operate a website. It is important for users to register their new devices to insure that all product upgrade and other product information will be received by the user. This requirement is especially important if the access device is built without a physical way of adding software, or replacing software in case of a system crash.

Indeed, many PDA's do not allow for the direct loading of new software. The software must be first loaded onto a personal computer, and then loaded onto the PDA utilizing a predetermined loading sequence. While this system works well, an intermediate device is required. This is a costly requirement. Furthermore, with a new breed of Internet appliance similarly lacking a physical way to add new software, a user may have only this appliance and not own another stand-alone computer.

Therefore, it would be beneficial to provide a registration system for registering a computerized access device that overcomes the drawbacks of the prior art.

Other objects and advantages of the invention will in part be obvious and will in part be apparent from the specification and the drawings.

### SUMMARY OF THE INVENTION

Therefore, in accordance with the invention, registration for a website is provided via a back end server connected directly to an ISP, and bypassing load balanced front end servers that are providing the computing power to run a website. In this way, resources for meeting user's requests are not compromised when other users wish to register for the website.

The invention accordingly comprises the several steps and the relation of one or more of such steps with respect to each of the others, and the system embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 is a block diagram depicting an embodiment of the registration system constructed in accordance with the invention; and

FIG. 2 is a flow chart diagram depicting an embodiment of the method in accordance with the invention.

### DETAILED DESCRIPTION OF THE PREFERRED EMBODIMENTS

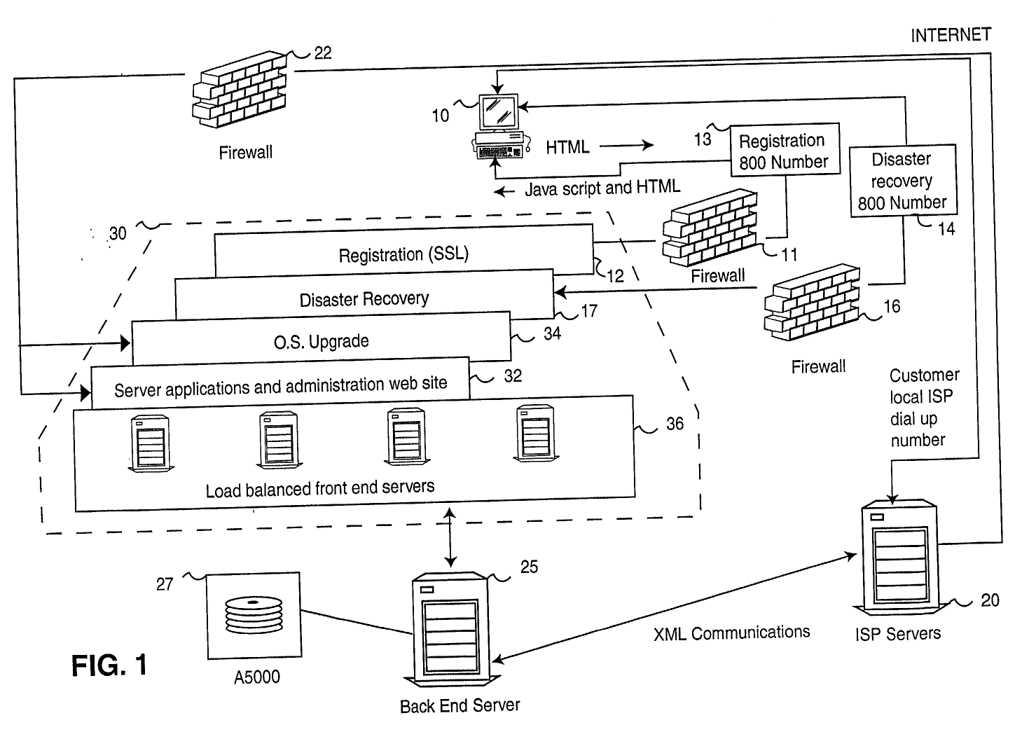

An embodiment in accordance with the invention will now be described, making reference first to FIG. 1. As is shown in FIG. 1, an Internet communication device 10 is shown. This communication device preferably comprises an Internet appliance without local information entry means, such as a lack of a disk drive, but may comprise any commonly known devices such as a cellular telephone with web access, a personal information manager with web access, standard desktop computer, or any other device for accessing the World Wide Web and Internet, either wirelessly, using a land line, satellite transmission or the like. Additionally, this system is not only limited to the Internet and World Wide Web, but may also be applied to any other communication network, either proprietary or otherwise. Preferably, this appliance is an evilla device manufactured by Sony Electronics Corporation.

During normal use, communication device 10 is coupled with the Internet and World Wide Web via an Internet Service Provider (ISP) 20. This ISP allows a user to temporarily connect to the Internet via one of its dedicated access points. Thus, a user dials up a number, or accesses its ISP in any appropriate manner. A link is then provided from the ISP to the user, and from the ISP to any other desired website via the Internet. The desired destination website is typically determined in accordance with a specific request by the user. In this manner, the user may view any desired website on the World Wide Web, via the Internet, and in accordance with an agreement between the user and the ISP.

As is further shown in FIG. 1, when a user wishes to access a particular web page 30, a link is established from ISP 20 to the desired website 30, in accordance with a request from the user. Often, a firewall 22 is present on the communication link between ISP 20 and website 30. This firewall monitors communications between the ISP and the website to insure that only data that is allowed to be transferred from website 30 to ISP 20 is allowed to be accessed. Thus, the firewall aids in protecting the information on website 30, the integrity and safety of website 30, and any other systems associated with the software or hardware of website 30.

In this embodiment of the invention, the producer, sponsor, or other support entity of user communication device 10 provides website 30, by way of example only. Website 30 includes any number of features that are determined to be of great use to users of communication device 10. Website 30 includes a registration by secure sockets layer 12, a disaster recovery function 17, an operating system upgrade function 34, and a server applications and administration of website function 32. Registration function 12 allows for communication device 10 to be registered at website 30. Disaster recovery function 17 allows for registered users to obtain data that is backed up for them at the website or reinstallation of operating systems of the like upon a system crash. For example, each time a registered user logs on to the web site, a picture of the entire memory of communication device 10 may be saved at website 30 and disaster recovery function 17. If a user's communication device 10 malfunctions, is lost, or for any other reason the contents of its memory is erased, a new copy of the operating system, and the stored memory can be recovered from website 30 and specifically from disaster recovery function 17. The stored memory preferably comprises at least a functioning operating system, and appropriate phone number user data or other appropriate data for the user to connect to his or her ISP.

Operating system upgrade function 34 allows for the operating system employed on communication device 10 to be upgraded. As additional functionality is made available to purchasers of a new communication device 10, users of older devices can also enjoy these upgraded features by upgrading their operating system. Service applications and administration website function 32 includes any number of programs for allowing functionality required for certain functioning of communication device to take place at website 30. Thus, for any number of complicated functions, processing could take place at website 30, an answer being forwarded back to communication device 10. Also, any number of other programs for actual operation of the website is provided. Finally, certain routine maintenance of communication device 10 may be performed.

All of the functioning of website 30 is performed on one or more load balanced front end servers 36. These servers are provided for any number of users to access the information at website 30 at the same time. While some practical limit does exist as to the amount of traffic that can be handled by servers 36, additional servers can be added as necessary. Thus, in most cases, any user should be able to access website 30 at any time.

As is further shown in FIG. 1, all but one of the access points to website 30 are protected by a firewall. Thus, it is only access via ISP 20, and a back end server 25 that does not include a firewall. In accordance with the invention back end server 25 is directly connected to ISP server 20. Communication between the two is preferably performed using a standard XML protocol, but may employ any other communication protocol. Back end server 25 is coupled with a storage device 27 for storing data associated with back end server 25, and most importantly for the various registration entities. During an initial communication and registration process communication device 10 automatically dials up a registration 800 number to begin the registration process for communication device 10. As shown in FIG. 1, this process takes place via a link protected by firewall 16 designed to insure the security of website 30. After a connection is made between communication device 10 and website 30 using a secure sockets layer (SSL) to encode and protect the contents of the transition, information initially identifying communication device 10 is transmitted to website 30. An HTML request for registration is then sent from communication device 10 to website 30. This request is received by registration function 12 of website 30. In response to this request, a registration display screen page is transmitted from registration function 12 to communication device 10 using JAVA script and/or HTML protocols.

Once communication device 10 has received this registration display screen page, contact with website 30 is severed. The user then completes the displayed registration form on communication device 10. While the form is being completed by the user, or directly thereafter, a communication link is established between communication device 10 and a back end server 25 via a user's ISP server. Once the registration form has been completed, the information is transmitted to back end server 25 employing an XML communication protocol. The transmission of registration information is performed between ISP 20 and back end server 25, therefore avoiding burdening front end servers administering the website, and also avoiding any number of firewalls set up for the protection of website 30.

Once back end server 25 has received registration information for a particular user, that user and device are registered with the website. This registration process allows communication device 10 to utilize all features of website 30 in the future.

After registration, the user has a number of methods for accessing website 30. Of course, any number of access points may be provided, those shown in FIG. 1 being by way of example only.

Communication device 10 may connect to disaster recovery function 17 of website 30 in order to recover information that may have been lost by communication device 10, such as upon a system crash of communication device 10. This contact may be made by a direct dial-up connection between communication device 10 and website 30 specifically designed to receive disaster recovery requests or may be made alternatively via ISP server 20, or other appropriate data transfer protocol. Once contact is made, stored disaster recovery information is read from back end server 25 and provided to disaster recovery function 12. How this stored data is obtained will be discussed below. Information is preferably transmitted between communication device 10 and website 30 in accordance with the JAVA script and HTML protocols, but any other communication protocol may be employed. This connection is protected by a firewall 16. Thus only users who have previously registered in accordance with the procedure set forth above are able to access this registration function of website 30.

As is further shown in FIG. 1, communication may be provided between communication device 10, via ISP server 20, to website 30. A direct dial up connection may also be employed. This connection may link a registered user of communication device 10 with operating system upgrade function 34. This communication is protected by a firewall 22, employing registration information obtained from back end server 25. Via these communications, as noted above, the operating system of operating system upgrade function 34 may be transmitted to communication device 10. Thus, an operating system upgrade may be provided to a registered communication device.

The communication between communication device 10 and website 30, via ISP 20 may link communication device 10 with server applications and administration website function 32. In addition to allowing for various programs to be run at website 30 at the request of, and for the benefit of, communication device 10, various data backups and other administrative processing is performed. Thus, for example, each night, a data backup from communication device 10 to website 30 may be performed. If communication device 10 crashes, this stored information will be available via disaster recovery function 17.

To begin such a backup procedure, communication device 10 sets up a link to server applications and administration function 32. Predetermined information is transmitted back to communication device 10 from server applications and administration function 32.

After receipt of this predetermined information, data to be backed up is sent directly to back end server 25, bypassing website 30, and most importantly front end servers 36. In this manner, an efficient downloading procedure may be established.

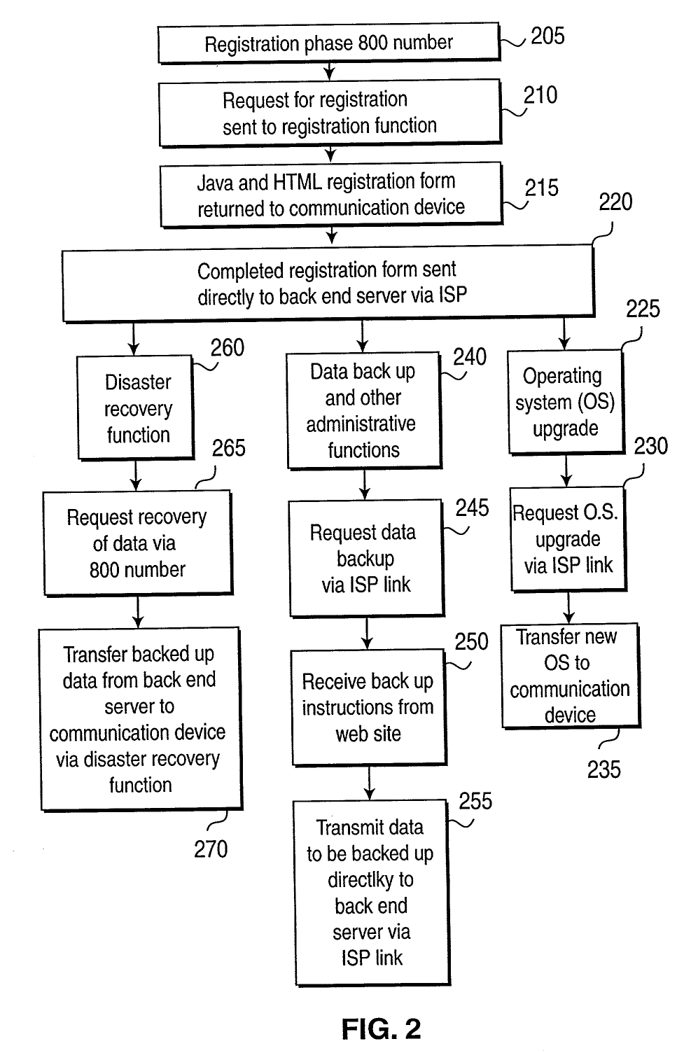

Referring next to FIG. 2, a flow of information in accordance with the present invention will be described. First, when a new communication device is purchased, at step 205, a registration phase is performed via an 800 number. After a connection of the new communication to a website via the 800 number is established through a firewall, initial identification information and a request for registration of the communication device is sent from the communication device to a registration function of the website in step 210. Upon receipt of this request, a JAVA script and HTML registration form is returned to the communication device at step 215. This registration form is completed by a user and forwarded to a back end server associated with the website via a standard ISP connection at step 220.

After registration, the user has a number of options in which to interface with the website, three being shown in the present invention.

As a first choice, as shown in FIG. 2, the communication device may request an operating system upgrade at step 225. This request for operating system upgrade is forwarded to the website and specifically to an operating system upgrade function via the standard ISP connection or link. After this request is received by the operating system upgrade function of the website, a new operating system is transferred to the communication device and installed therein.

Next, a data backup and any number of other administrative functions may be selected and performed. While the description of the data backup will be given herein, any other administrative functions may be performed in a similar manner. At step 240, data backup and other administrative functions are determined to be desired. Thereafter, at step 245, a request for data backup is sent to the website, and more specifically is sent to a server application and administration website function via a standard ISP connection or link. In response to this request, the website transmits, and the communication device receives, instructions for backing up the data contained within the communication device. Data to be backed up is thereafter transmitted directly to the back end server via the ISP link, thereby bypassing the front end servers of the website. This transmission is similar to that taking place in accordance with the original registration steps.

Finally, a disaster recovery function may be employed. Upon implementation of a disaster recovery function at step 260, a request for recovery of data is made via an 800 number at step 265. Upon request and proper identification of communication device, backed up data is transferred from the backup server to the communication device via a disaster recovery function included within the website. This connection is not performed via the ISP link, because the recovery information may be required to dial up the user's ISP. The 800 numbers for both registration and disaster recovery are burned into a chip in the communication device and therefore cannot be forgotten.

Therefore, in this manner, highly intensive data transfer operations can be performed by bypassing the front end servers of a website, thereby increasing the efficiency of the website functionality as well as leaving sufficient competing power for other users. Registration for a website, as well as various other time-consuming processes, are provided via a back end server connected directly to an ISP, and bypassing load balanced front end servers 36 that are providing the computing power to run website 30. In this way, resources for meeting user's requests are not compromised when other users wish to register for website 30, or use of other program features of the website.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A method of communication between a communication device and a website, comprising the steps of:
establishing a first connection between said communication device and said website via a front end server hosting said website and displaying pages of said website to said communication device;
transmitting information from said communication device to said front end server;
receiving information at said communication device from said front end server;
establishing a second connection between said communication device and said website via a back end server not hosting said website; and
transmitting information from said communication device to said back end server.

2. The method of claim 1, wherein said first connection is terminated before said second connection is established.

3. The method of claim 1, wherein said information transmitted from said communication device to said front end server comprises at least identification information.

4. The method of claim 1, wherein said information received at said communication device from said front end server comprises at least instruction information allowing said back end server to recognize said communication device.

5. The method of claim 1, wherein said information transmitted from said communication device comprises registration information.

6. The method of claim 1, wherein said information received by said communication device from said front end server comprises operating system software.

7. The method of claim 1, wherein said second connection between said communication device and said back end server is established via an Internet Service Provider associated with said communication device

8. The method of claim 1, wherein said information transmitted from said communication device to said back end server comprises data to be backed up on said back end server.

9. The method of claim 1, further comprising the step of receiving information at said communication device from said back end server.

10. The method of claim 9, wherein said information received at said communication device comprises information backed up from said communication device on said back end server.

11. A method of communication between a website and a communication device, comprising the steps of:
establishing a first connection between said website and said communication device via a front end server hosting said website and displaying pages of said website from said front end server;
receiving information at said front end server from said communication device;
transmitting information from said front end server to said communication device;
establishing a second connection between said web site via a back end server not hosting said website and said communication device; and
receiving information at said back end server from said communication device.

12. The method of claim 11, wherein said first connection is terminated before said second connection is established.

13. The method of claim 11, wherein said information received at said front end server from said communication device comprises at least identification information.

14. The method of claim 11, wherein said information transmitted from said-front end server to said communication device comprises at least instruction information allowing said back end server to recognize said communication device.

15. The method of claim 11, wherein said information received at said front end server comprises registration information.

16. The method of claim 11, wherein said information transmitted from said front end server to said communication device comprises operating system software.

17. The method of claim 11, wherein said second connection between said back end server and said communication device is established via an Internet Service Provider associated with said communication device

18. The method of claim 11, wherein said information received at said back end server comprises data to be backed up on said back end server.

19. The method of claim 11, further comprising the step of transmitting information from said back end server to said communication device.

20. The method of claim 19, wherein said transmitted from said back end server comprises information backed up from said communication device on said back end server.

21. A computer system for hosting a website, comprising:
a front end server hosting said website and displaying pages of said website to a communication device in communication with said website, said front end server receiving information from said communication device and transmitting information to said communication device; and
a back end server associated with said website but not hosting said website coupled with said front end server, said back end server receiving information from said communication device upon establishment of a connection between said back end server and said communication device.

22. A system of communication between a communication device and a website, comprising:
means for establishing a first connection between said communication device and said website via a front end server hosting said website and displaying pages of said website to said communication device;
means for transmitting information from said communication device to said front end server;
means for receiving information at said communication device from said front end server;
means for establishing a second connection between said communication device and said web site via a back end server not hosting said website; and
means for transmitting information from said communication device to said back end server.

23. A system of communication between a website and a communication device, comprising:
means for establishing a first connection between said website and said communication device via a front end server hosting said website and displaying pages of said website from said front end server;
means for receiving information at said front end server from said communication device;
means for transmitting information from said front end server to said communication device;
means for establishing a second connection between said web site via a back end server not hosting said website and said communication device; and
means for receiving information at said back end server from said communication device.

24. A computer program for providing communication between a communication device and a website, said computer program comprising:
an instruction for establishing a first connection between said communication device and said website via a front end server hosting said website and displaying pages of said website to said communication device;
an instruction for transmitting information from said communication device to said front end server;
an instruction for receiving information at said communication device from said front end server;
an instruction for establishing a second connection between said communication device and said web site via a back end server not hosting said website; and
an instruction for transmitting information from said communication device to said back end server.

25. A computer program for providing communication between a website and a communication device, said computer program comprising:
an instruction for establishing a first connection between said website and said communication device via a front end server hosting said website and displaying pages of said website from said front end server;
an instruction for receiving information at said front end server from said communication device;
an instruction for transmitting information from said front end server to said communication device;
an instruction for establishing a second connection between said web site via a back end server not hosting said website and said communication device; and
an instruction for receiving information at said back end server from said communication device.
